(19) United States
(12) Patent Application Publication
(10) Pub. No.: US 2007/0041446 A1
(43) Pub. Date: Feb. 22, 2007

(54) Display apparatus and control method thereof

(75) Inventors: Hwa-seok Seong, Suwon-si (KR); Jong-sul Min, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/503,981

(22) Filed: Aug. 15, 2006

(30) Foreign Application Priority Data
Aug. 16, 2005 (KR) 2005-0074977

(51) Int. Cl. H04N 11/02; H04N 5/253

(52) U.S. Cl. 375/240.16; 348/97

(57) ABSTRACT

A display apparatus and a control method which can effectively remove a false contour and a motion blur from a moving picture when an image includes a repetitive pattern of a frame are provided. A display apparatus comprises a pattern determiner to determine a frame pattern of the input image, a motion vector calculator to calculate a motion vector on the basis of a first frame corresponding to a first presented frame among the frames of a repetitive pattern, and a second frame corresponding to an image that is different from the frames of the repetitive pattern after the repetitive pattern is generated, when the input image includes the repetitive pattern, a motion compensating brightness calculator to calculate motion compensating brightness at the beginning of each subfield according to the motion vector, an integral brightness calculator to calculate integral brightness of the quantity of light emitted in the subfield for a predetermined period of time along the motion vector, and an emission pattern selector to select whether light is emitted in the subfield on the basis of the motion compensating brightness and the integral brightness.

### CROSS-REFERENCE TO RELATED APPLICATIONS

This application claims the benefit under 35 U.S.C. § 119(a) of Korean Patent Application No. 2005-0074977, filed on Aug. 16, 2005, in the Korean Intellectual Property Office, the entire disclosure of which is hereby incorporated by reference.

### BACKGROUND OF THE INVENTION

1. Field of the Invention

The present invention relates to a display apparatus and a control method thereof. More particularly, the present invention relates to a display apparatus capable of representing gradation of an input image by a timesharing method using a subfield and a control method thereof.

2. Description of the Related Art

As shown in FIG. 1, subfields generally form one frame of an input image. Here, the subfields differ in their weight respectively, and the brightness during one frame varies according to whether light emission in each subfield occurs.

A display apparatus using a timesharing method to represent gradation can experience a problem such as a false contour which may occur while displaying a moving picture including a dynamic image. For example, a plasma display panel (PDP) and a digital mirror device (DMD), among others may experience a false contour occurring during the display of a moving picture including a dynamic image. Here, the false contour denotes that an afterimage like a contour line persists according to a difference in gradation between a dynamic area and its neighbor that is visually accumulated.

Also, a motion blur frequently occurs, which generates an indistinct outline of the dynamic image.

To solve these problems, many methods have been proposed. However, the conventional methods do not effectively solve the problems of the false contour and the motion blur.

A television broadcast employs various systems based on the National Television System Committee (NTSC) and a phase alternation line (PAL) among others according to nations and locations. In contrast to the movies, the NTSC runs at a rate of 30 frames per second with two fields per frame (60 fields per second), and the PAL runs at a rate of 25 frames per second (50 fields per second). Here, the movies based on a film image run. Therefore, to broadcast a film image at a rate of 24 frames per second, on the television or the like, its frame rate should be properly converted.

A method of properly converting the frame rate is illustrated in FIGS. 2A and 2B.

As shown in FIG. 2A, to process the film image in PAL, a frame is transmitted together with the same frames twice in subsequent fields. For example, the frame is transmitted in a “2:2” method, in which the frames are repeated twice, respectively. Alternatively, as shown in FIG. 2B, to process the film image in NTSC, a “3:2” method is used, such as, a first frame is repeated three times and a second frame is repeated two times.

When film images are involved, the repeated frame appears throughout a video signal. FIG. 3 illustrates a motion compensating subfield method for removing the false contour and the motion blur of the film image in the conventional display apparatus. As shown in FIG. 3, in the conventional display apparatus, motion vectors estimated between frames [N, N+1] and between frames [N+2, N+3] are ‘0’, so that the subfields of the Nth and (N+2)^{th} frame are arranged as a zero motion state. Further, the motion vectors estimated between frames [N+1, N+2] are non-zero, so that the subfields of the (N+1)^{th} frame are rearranged according to the estimated motion vector.

However, the human eye cannot perceive the quantity of light during one frame from the (N+1)^{th} frame on the basis of the quantity of light perceived during one frame from the beginning of the n^{th} frame. That is, the human eye perceives the quantity of light continuously and not by a unit of frame.

This will be described below with reference to FIG. 4. As shown in FIG. 4, the human eye instantaneously perceives brightness integrated from initial time of a continuous light emission period. In a period of T1 the brightness of only motionless frames is integrated. In a period from T2 to T6 the brightness of both the motionless frames and the motion frames is integrated. The human eye perceives the quantity of light of the subfields that are rearranged along a moving direction and the quality of light of the subfields that are not rearranged in the motionless frame, so that the false contour and the motion blur of the moving picture are not decreased.

Particularly, in the case where the same frame is repeated like the film image, the false contour and the motion blur are distinct.

Accordingly, there is a need for an improved system and method to effectively remove the false contour and the motion blur from the moving picture when an image includes a repetitive pattern of a frame.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a display apparatus and a control method thereof, which can effectively remove a false contour and a motion blur from a moving picture when an image includes a repetitive pattern of a frame.

Another aspect of an exemplary embodiment of the present invention can achieved by providing a display apparatus representing gradation of an input image by a timesharing method using a subfield. The display apparatus comprises a pattern determiner, a motion vector calculator, a motion compensating brightness calculator, an integral brightness calculator, and an emission pattern selector. The pattern determiner determines a frame pattern of the input image. The motion vector calculator calculates a motion vector on the basis of a first frame corresponding to a first presented frame among the frames of a repetitive pattern, and a second frame corresponding to an image that is firstly different from the frames of the repetitive pattern after the repetitive pattern is generated, when the input image includes the repetitive pattern. The motion compensating brightness calculator calculates motion compensating brightness at the beginning of each subfield according to the motion vector the integral brightness calculator calculates integral brightness of the quantity of light emitted in the subfield for a predetermined period of time along the motion vector, and the emission pattern selector selects whether light is emitted in the subfield on the basis of the motion compensating brightness and the integral brightness.

According to another exemplary embodiment of the present invention, the motion compensating brightness calculator calculates the brightness of some subfields among a plurality of subfields, included in the frames from the first frame before the second frame is started, based on the brightness of the first frame and the motion vector. The motion compensating brightness calculator also calculates the brightness of the other subfields among the plurality of subfields based on the brightness of the second frame and the motion vector.

According to another exemplary embodiment of the present invention, the pattern determiner further includes a film image detector to detect whether the input image is a film image on the basis of the pattern of the frame. When the film image detector detects the input image as a PAL film image, the motion compensating brightness calculator calculates the brightness of the subfield included in the first frame on the basis of the brightness of the first frame and a first vector different in direction from the motion vector and that has half the magnitude of the motion vector. The motion compensating brightness calculator also calculates the brightness of the subfield included in a third frame continuous to and repeated from the first frame on the basis of the brightness of the second frame and a second vector with the same direction as the motion vector and that has half the magnitude of the motion vector.

According to another exemplary embodiment of the present invention, the pattern determiner further includes a film image detector to detect whether the input image is a film image on the basis of the pattern of the frame. When the film image detector detects the input image as an NTSC film image and determines that there are three repetitive frames, the motion compensating brightness calculator calculates the brightness accordingly. For example, the brightness of the subfield included in the first frame among the repetitive three frames is calculated based on the brightness of the first frame and a first vector different in direction from the motion vector with ⅓ magnitude of the motion vector. The brightness of the subfield included in the third frame among the repetitive three frames is calculated based on the brightness of the second frame and a second vector with the same direction as the motion vector and with a magnitude smaller by ⅓ of the motion vector. The brightness of some subfields included in the second frame among the repetitive three frames is calculated based on the brightness of the first frame and a third vector different in direction from the motion vector with half the magnitude of the motion vector. The brightness of the other subfields included in the second frame is calculated based on the brightness of the second frame and a fourth vector with the same direction as the motion vector and with half the magnitude of the motion vector.

According to another exemplary embodiment of the present invention, the emission pattern selector selects the subfield as an emission state when a difference between the motion compensating brightness and the integral brightness is larger than a linear brightness.

Another aspect of an exemplary embodiment of the present invention can achieved by providing a method of controlling a display apparatus representing gradation of an input image by a timesharing method using a subfield. A frame pattern of the input image is determined. A motion vector is calculated based on a first frame corresponding to a first presented frame among the frames of a repetitive pattern, and a second frame corresponding to an image that is firstly different from the frames of the repetitive pattern after the repetitive pattern is generated, when the input image includes the repetitive pattern. Motion compensating brightness is calculated at the beginning of each subfield according to the motion vector. Integral brightness is calculated of the quantity of light emitted in the subfield for a predetermined period of time along the motion vector. A selection of whether light is emitted in the subfield is made based on the motion compensating brightness and the integral brightness.

According to another exemplary embodiment of the present invention, the operation of calculating motion compensating brightness comprises calculating the brightness of some subfields among a plurality of subfields, included in the frames from the first frame before the second frame is started. The brightness is calculated based on the brightness of the first frame and the motion vector; and calculating the brightness of the other subfields among the plurality of subfields based on the brightness of the second frame and the motion vector.

According to another exemplary embodiment of the present invention, the operation of determining a frame pattern of the input image comprises detecting whether the input image is a film image on the basis of the pattern of the frame. When the input image is detected as a PAL film image, the operation of calculating motion compensating brightness comprises calculating the brightness of the subfield included in the first frame on the basis of the brightness of the first frame and a first vector different in direction from the motion vector and having half the magnitude of the motion vector. Also, the brightness of the subfield included in the third frame continuous to and repeated from the first frame is calculated based on the brightness of the second frame and a second vector with the same direction as the motion vector and with half the magnitude of the motion vector.

According to another exemplary embodiment of the present invention, the operation of determining a frame pattern of the input image comprises detecting whether the input image is a film image based on the pattern of the frame. When the input image is detected as an NTSC film image and three repetitive frames are determined, the operation of calculating motion compensating brightness comprises calculating the brightness of the subfield included in the first frame among the repetitive three frames based on the basis of the brightness of the first frame and a first vector different in direction from the motion vector and having ⅓ magnitude of the motion vector. Also, the brightness of the subfield included in the third frame among the repetitive three frames is calculated based on the brightness of the second frame and a second vector having the same direction as the motion vector and having ⅓ magnitude of the motion vector. The brightness of some subfields included in the second frame among the repetitive three frames is calculated based on the brightness of the first frame and a third vector different in direction from the motion vector and having the half magnitude of the motion vector. The brightness of the other subfields included in the second frame is calculated based on the brightness of the second frame and a fourth vector having the same direction as the motion vector and having half the magnitude of the motion vector.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other exemplary objects, features, and advantages of certain exemplary embodiments of the present invention will be more apparent from the following description taken in conjunction with the accompany drawings, in which:

FIG. 1 illustrates subfields for representing gradation of an input image by a time-sharing method;

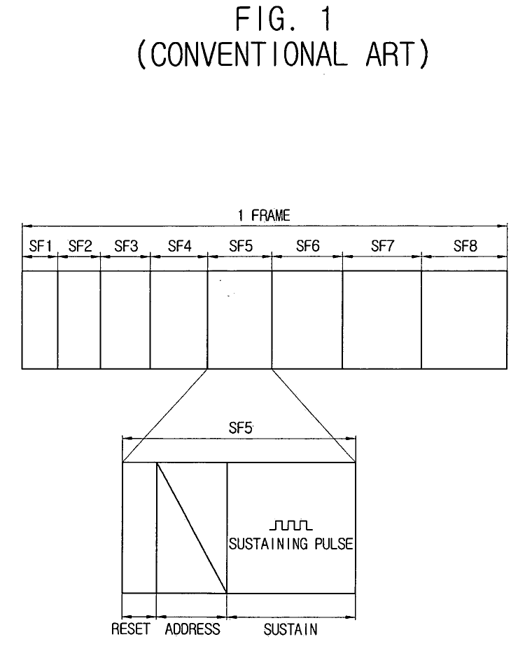

FIG. 2A illustrates frames of a film image in PAL;

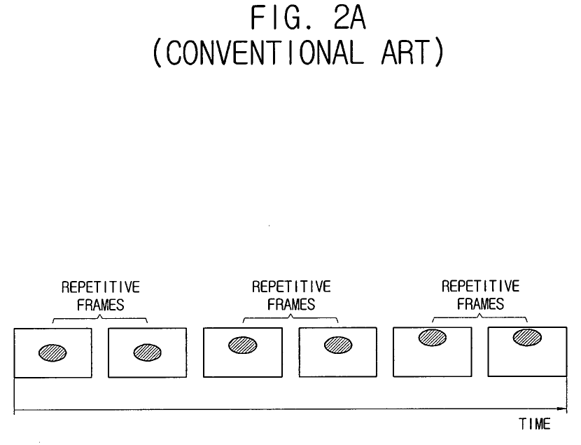

FIG. 2B illustrates frames of a film image in NTSC;

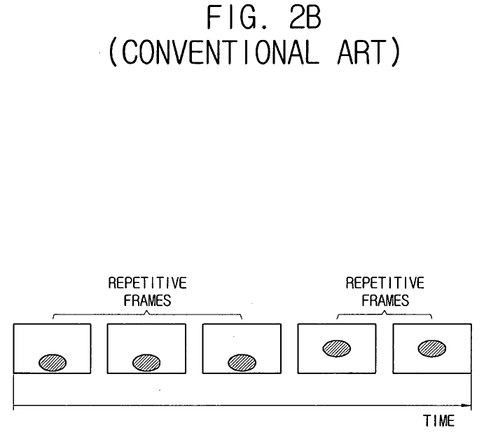

FIG. 3 is a graph for calculating a motion vector and motion compensating brightness in a conventional display apparatus;

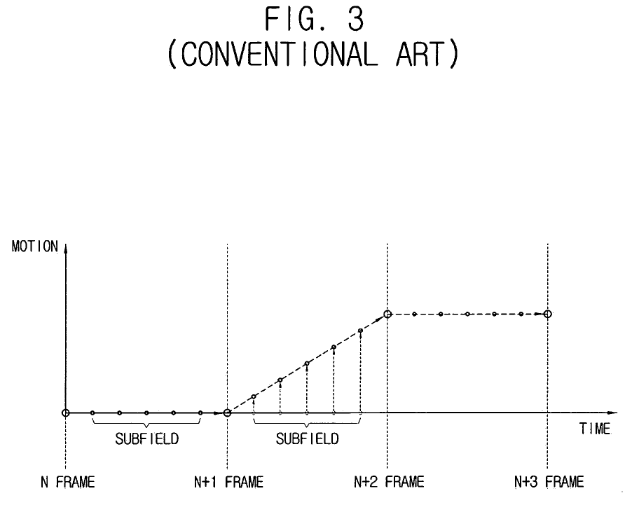

FIG. 4 is a graph illustrating a relationship between the subfield and an integral period for the human eye at a point of time in the conventional display apparatus;

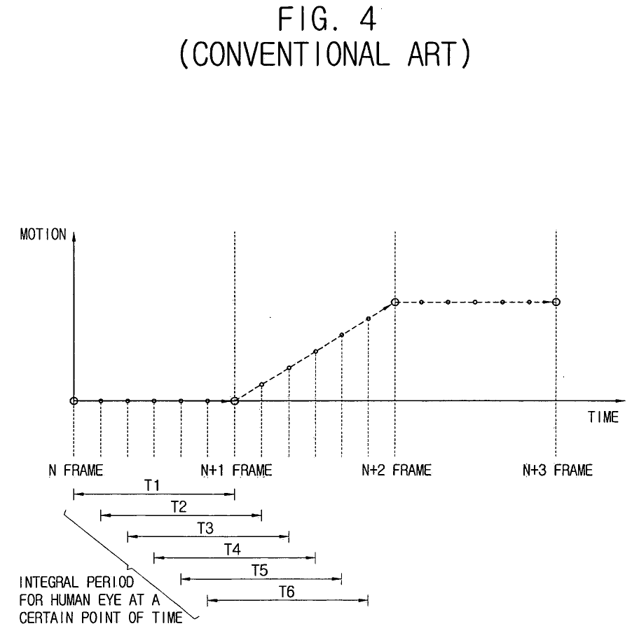

FIG. 5 is a control block diagram of a display apparatus according to an exemplary embodiment of the present invention;

FIG. 6 is a graph of processing a PAL film image in the display apparatus according to an exemplary embodiment of the present invention;

FIG. 7 is a graph of processing an NTSC film image in the display apparatus according to an exemplary embodiment of the present invention; and

FIG. 8 is a control flowchart of the display apparatus according to an exemplary embodiment of the present invention.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

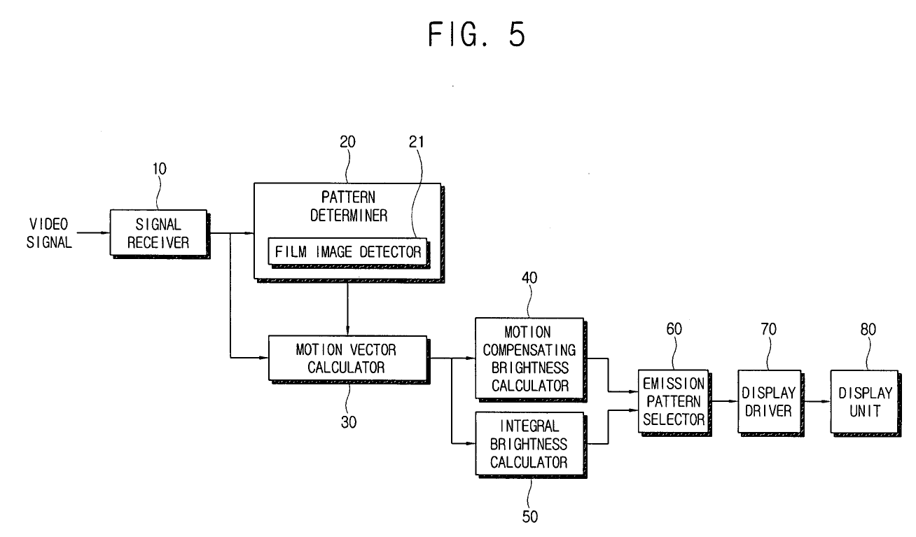

As shown in FIG. 5, a display apparatus according to an exemplary embodiment of the present invention includes a pattern determiner 20, a motion vector calculator 30, a motion compensating brightness calculator 40, an integral brightness calculator 50, and an emission pattern selector 60. Further, the display apparatus according to an exemplary embodiment of the present invention includes a signal receiver 10, a display driver 70, and a display unit 80.

The pattern determiner 20 determines a frame pattern of an input image. Particularly, the pattern determiner 20 determines whether frame data is periodically repeated.

Further, the pattern determiner 20 includes a film image detector 21 to detect whether the input image is a film image based on the frame pattern. The film image detector 21 detects the film image transmitted by a PAL method when the pattern determiner 20 determines that the frame pattern is repeated in a ratio of 2:2. Alternatively, the film image detector 21 detects the film image transmitted by a NTSC method when the pattern determiner 20 determines that the frame pattern is repeated in a ratio of 3:2.

The PAL method and the NTSC method can be determined on the basis of the frequency of an input video signal. Further, most televisions support the PAL or the NTSC.

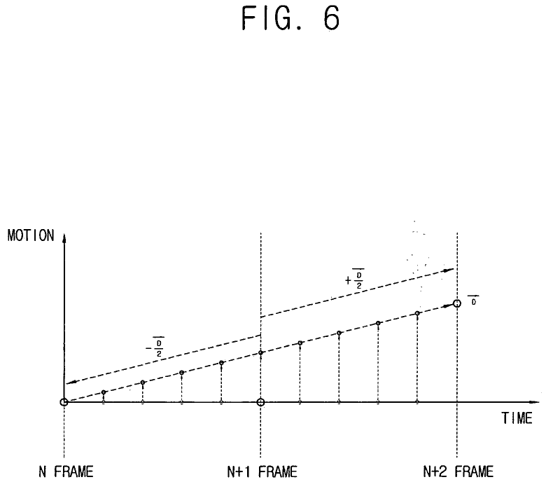

When the pattern determiner 20 determines that the frame of the input image has a repetitive pattern, the motion vector calculator 30 calculates a motion vector on the basis of a first frame corresponding to a first presented frame among the frames of the repeating pattern, and a second frame corresponding to an image that is different from the frames of the repetitive pattern after the repetitive pattern is generated. For example, the N^{th} frame is different from the (N−1)^{th} frame. In this case, when the (N+1)^{th} frame is equal to the N^{th} frame but the (N+2)^{th} frame is different from the N^{th} frame, the N^{th} frame and the (N+2)^{th} frames are regarded as the first frame and the second frame, respectively. As shown in FIG. 6, \vec{D} indicates the motion vector.

The motion compensating brightness calculator 40 calculates motion compensating brightness at the beginning of a subfield according to the motion vector.

At this time, the motion compensating brightness calculator 40 calculates the brightness of some subfields among a plurality of subfields included in the frames from the first frame before the second frame is started, based on the brightness of the first frame and the motion vector. Further, the motion compensating brightness calculator 40 calculates the brightness of the other subfields among the plurality of subfields based on the brightness of the second frame and the motion vector.

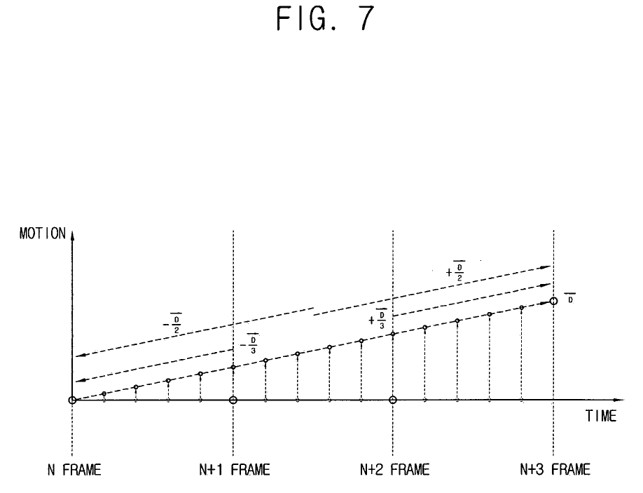

In connection with two PAL and NTSC methods, the detailed calculation will be described below with reference to FIGS. 6 and 7. In the PAL method, the repetitive frames are two and two.

As shown in FIG. 6, when the motion vector-calculator 30 calculates the motion vector \vec{D}, the motion compensating brightness calculator 40 can use a vector

$$- \frac{\vec{D}}{2}$$

and the brightness information of the N^{th} frame in order to calculate the brightness at the beginning of the subfield included in the N^{th} frame.

That is, the motion compensating brightness can be calculated by the following Equation 1.

$${I}_{MC} ( \vec{x} , t - α ) = I ( \vec{x} - \frac{( 1 - α )}{2} \vec{D} , t - T ) \qquad Equation 1$$

Where, \vec{x} is a current position; α is a point of time when each subfield emits light; \vec{D} is a motion vector; and T is a period of one frame.

Further, the motion compensating brightness calculator 40 can use a vector

$$+ \frac{\vec{D}}{2}$$

and the brightness information of the (N+2)^{th} frame in order to calculate the brightness at the beginning of the subfield included in the (N+1)^{th} frame.

That is, in the subfields of the (N+1)^{th} frame, the motion compensating brightness can be calculated by the following Equation 2.

$${I}_{MC} ( \vec{x} , t - α ) = I ( \vec{x} + \frac{α}{2} \vec{D} , t ) \qquad Equation 2$$

Where, variables correspond to those of Equation 1.

Thus, the motion compensating brightness calculated at each subfield can be used as a target value of integral brightness resulted from the calculation of the integral brightness calculator 50 when the emission pattern selector 60 (to be described later) selects whether light is emitted in each subfield.

The integral brightness calculator 50 integrates the quantity of light emitted in the subfield along the motion vector for a predetermined time, thereby calculating the integral brightness. That is, the integral brightness calculator 50 calculates the brightness integrated along the motion vector obtained by the motion vector calculator 30 for a predetermined period (for example, one period). At this time, the calculated integral brightness corresponds to the quantity of light integrated by the human eye along the motion vector. The integral brightness calculator 50 calculates an integral value of every subfield for a predetermined period, and determines the quantity of light to be emitted in each subfield by applying subfield-interpolation when the motion vector does not pass an integer pixel position. Therefore, the integral brightness calculator 50 can calculate the integral brightness by the following Equation 3.

$${I}_{A} ( \vec{x} , {t}_{i} ) = {\sum }_{j = 0}^{r - 1} {W}_{j} {SF}_{j} ( \vec{x} - ( \frac{{t}_{i} - tj}{2 T} ) \vec{D} , n ) \qquad Equation 3$$

Where, tᵢ is a point of time corresponding to a current subfield to be processed; Wⱼ is a brightness weight of the j^{th} subfield; SFⱼ is data obtained by the subfield-interpolation along the motion vector; and n indicates the n^{th} frame. Here, n corresponds to t when i is equal to j, and corresponds to t-T when i is different from j.

The emission pattern selector 60 selects whether light is emitted in each subfield on the basis of the motion compensating brightness and the integral brightness. That is, the emission pattern selector 60 determines whether light is emitted in the respective subfields forming the frame. For this, the emission pattern selector 60 can select the light to be emitted in the current subfield only when the motion compensating brightness is larger than the sum of the integral brightness and the brightness weight of the current sub-field. Further, the emission pattern selector 60 may employ linear brightness of each subfield as a variable for selecting the emission pattern.

For example, the emission pattern selector 60 can select the emission pattern to satisfy the following Equation 4.
if (I_{MC}(\vec{x},tᵢ)>=I_{A}(\vec{x},tᵢ)+Wᵢ)
if (I_{MC}(\vec{x},tᵢ)−I_{A}(\vec{x},tᵢ)>Sᵢ)SFᵢ(\vec{x},tᵢ)=1
else SFᵢ(\vec{x},tᵢ)=0 Equation 4
Here, Si denotes the linear brightness. The linear brightness is obtained by summing up the weights of the subfield brightness. For example, when the weights of the subfield brightness are [1, 2, 4, 8, 16, 24, 32], the linear brightness is [0, 1, 3, 7, 15, 31, 55], respectively.

Below, a process of determining the emission pattern considering the linear brightness will be described with reference to the following Table 1.

TABLE 1

| Emission | | | | | | | | |
|---|---|---|---|---|---|---|---|---|
| Pattern | | Subfield | | | | | | |
| Generation | Subfield | Brightness | | | | | | Emission |
| Order | No. | Weight | Sᵢ | I_{MC} | I_{A} | I_{MC} >= I_{A} + Wᵢ? | I_{MC} >= I_{A} + Wᵢ? | pattern |
| 1 | SF10 | 68 | 187 | 80 | 0 | YES | NO | 0 |
| 2 | SF9 | 56 | 131 | 80 | 0 | YES | NO | 0 |
| 3 | SF8 | 44 | 87 | 80 | 0 | YES | NO | 0 |
| 4 | SF7 | 32 | 55 | 80 | 0 | YES | YES | 1 |
| 5 | SF6 | 24 | 31 | 80 | 32 | YES | YES | 1 |
| 6 | SF5 | 16 | 15 | 80 | 56 | YES | YES | 1 |
| 7 | SF4 | 8 | 7 | 80 | 72 | YES | YES | 1 |
| 8 | SF3 | 4 | 3 | 80 | 80 | NO | NO | 0 |
| 9 | SF2 | 2 | 1 | 80 | 80 | NO | NO | 0 |
| 10 | SF1 | 1 | 0 | 80 | 80 | NO | NO | 0 |

According to an exemplary implementation, Table 1 shows operations of the emission pattern selector 60 with regard to a gradation of 80 if the image includes no motion. Because the image includes no motion, the motion compensating brightness about all subfields has the gradation of 80 which is a current pixel position to be processed. In the first generated subfield of SF10, there is no determined emission pattern, so that the integral brightness becomes 0, thereby selecting the subfield as a non-emission state on the basis of Equation 4. Then, the subfield is selected by Equation 4 as an emission state from the fourth generated subfield of SF7. Further, other emission patterns are shown like those of Table 1 on the basis of Equation 4. When the linear brightness is considered while calculating the emission pattern, it is possible to minimize problems such as gradation inversion according to a lasting time of a fluorescent material, flicker due to emission center variation, and insufficient margin for writing a recording pulse, among others.

In the NTSC method, the repetitive frames are three and two, respectively. That is, the same three frames are repeated and then the same two frames are repeated, and so on.

When the same two frames are repeated, the film image can be processed like that of the PAL method. Therefore, a method of processing the film image of when the same three frames are repeated will be schematically described below.

As shown in FIG. 7, the N^{th} frame, the (N+1)^{th} frame and the (N+2)^{th} frame should all have respective subfields rearranged along a successive motion direction in order to decrease a false contour and a motion blur. Therefore, in the N^{th} frame and the (N+2)^{th} frame, the motion compensating brightness is calculated with a motion vector having ⅓ magnitude of the motion vector calculated by the motion vector calculator 30. Then, the respective emission states of the subfields are rearranged on the basis of the calculated motion compensating brightness.

Further, the (N+1)^{th} frame uses two vectors obtained by dividing the motion vector in half.

For example, the motion vector calculator 30 calculates the motion vector \vec{D} on the basis of the N^{th} frame and the (N+3)^{th} frame.

The motion compensating brightness calculator 40 can calculate the motion compensating brightness of the subfields included in the N^{th} frame on the basis of the vector

$$- \frac{\vec{D}}{3}$$

and the brightness data of the N^{th} frame. Further, the motion compensating brightness calculator 40 can calculate the motion compensating brightness of the subfields included in the (N+2)^{th} frame on the basis of the vector

$$+ \frac{\vec{D}}{3}$$

and the brightness data of the (N+3)^{th} frame. Also, the motion compensating brightness calculator 40 can calculate the motion compensating brightness of the subfields included in the (N+1)^{th} frame by calculating the subfield brightness of a first half of the subfield included in the (N+1)^{th} frame on the basis of the vector

$$- \frac{\vec{D}}{2}$$

and the brightness data of the N^{th} frame and by calculating the subfield brightness of a second half of the subfield on the basis of the vector

$$+ \frac{\vec{D}}{2}$$

and the brightness data of the (N+3)^{th} frame.

Likewise, the integral brightness calculator 50 and the emission pattern selector 60 in the NTSC film image may be used like those of the PAL film image.

The signal receiver 10 receives the video signal and performs an initial process. At this time, the signal receiver 10 may include an inverse gamma corrector (not shown) to convert the respective R, G and B brightness of an input image, and an error diffuser (not shown) to generate an error caused by representing the brightness as an integer to be reflected in neighboring pixels.

The display driver 70 drives the display unit 80 to display an image according to whether the light is emitted in the subfields selected by the emission pattern selector 60.

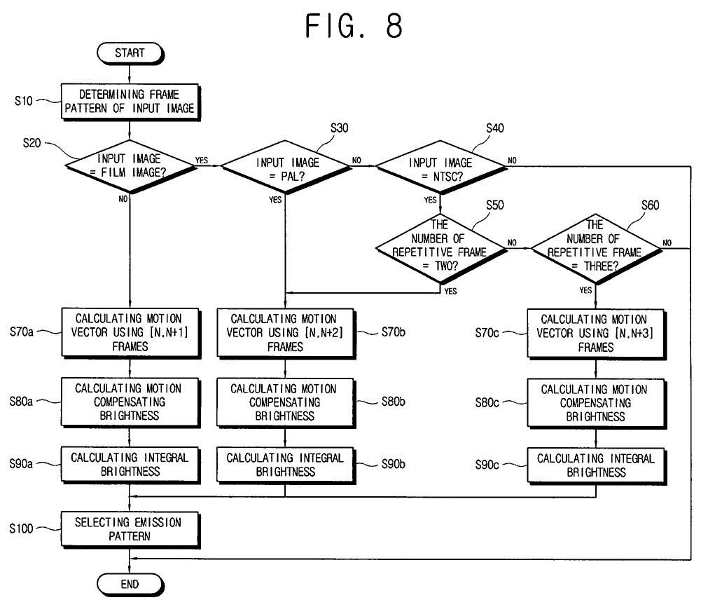

Below, a control method for the display apparatus according to an exemplary embodiment of the present invention will be described with reference to FIG. 8.

At operation S110, the pattern determiner 20 determines the pattern of the input image frame. At operation S20 the input image is not the film image, at operation S70a the motion vector calculator 30 calculates the motion vector on the basis of the N^{th} and (N+1)^{th} frames. At operation S80a, the motion compensating brightness calculator 40 calculates the brightness of the N^{th} frame, the brightness of the (N+1)^{th} frame, and the motion compensating brightness with the intermediate brightness of average brightness of these two frames.

At operation S90a, the integral brightness calculator 50 calculates the integral value of every subfield for one frame period.

In the meantime, when it is determined at the operations S20 and S30 that the input image is a film image and uses the PAL method, at operation S70b the motion vector calculator 30 calculates the motion vector on the basis of the N^{th} and (N+2)^{th} frames, and at operation S80b the motion compensating brightness calculator 40 calculates the motion compensating brightness of the subfield included in the N^{th} frame by Equation 1 and the motion compensating brightness of the subfield included in the (N+1)^{th} frame by Equation 2.

At operation S90b, the integral brightness calculator 50 calculates the integral brightness corresponding to the quantity of light sensed by the human eye for a predetermined period of time on the basis of Equation 3.

On the other hand, when a determination is made at the operations S20, S40 and S60 that the input image is a film image and uses the NTSC method and three frames are repeated, at operation S70c the motion vector calculator 30 calculates the motion vector on the basis of the N^{th} and (N+3)^{th} frames, and at operation S80c the motion compensating brightness calculator 40 calculates the motion compensating brightness of the respective subfields included in the N^{th}, (N+1)^{th} and (N+2)^{th} frames on the basis of the motion vector and the brightness information corresponding to the N^{th} frame and the (N+3)^{th} frame. At operation S90c, the integral brightness calculator 50 calculates the integral brightness corresponding to the quantity of light sensed by the human eye for a predetermined period of time along the motion vector calculated as described above.

At operation 100, the emission pattern selector 60 selects whether the light is emitted in the corresponding subfield based on the motion compensating brightness, the integral brightness and the linear brightness regardless of whether the input image is the film image.

As described above, the present invention provides a display apparatus and a control method thereof, which can effectively remove a false contour and a motion blur from a moving picture when an image includes repetitive patterns of a frame like a film image

While the present invention has been shown and described with reference to certain exemplary embodiments thereof, it will be understood by those skilled in the art that various changes in form and details may be made without departing from the principles and spirit and scope of the invention as defined by the appended claims and their equivalents.

What is claimed is:

1. A display apparatus representing gradation of an input image by a timesharing method using a subfield, the display apparatus comprising:
a pattern determiner for determining a frame pattern of the input image;
a motion vector calculator for calculating a motion vector based on a first frame corresponding to a first presented frame among the frames of a repetitive pattern, and a second frame corresponding to an image that is different from the frames of the repetitive pattern after the repetitive pattern is generated, when the input image comprises the repetitive pattern;
a motion compensating brightness calculator for calculating motion compensating brightness at the beginning of each subfield according to the motion vector;
an integral brightness calculator for calculating integral brightness of the quantity of light emitted in the subfield for a reference period of time along the motion vector; and
an emission pattern selector for selecting whether light is emitted in the subfield based on the motion compensating brightness and the integral brightness.

2. The display apparatus according to claim 1, wherein the motion compensating brightness calculator calculates the brightness of at least one subfield among a plurality of subfields, comprised in the frames from the first frame before the second frame is started, on the basis of the brightness of the first frame and the motion vector, and calculates the brightness of the other subfields among the plurality of subfields on the basis of the brightness of the second frame and the motion vector.

3. The display apparatus according to claim 2, wherein the pattern determiner further comprises a film image detector to detect whether the input image comprises a film image on the basis of the pattern of the frame, and
wherein the film image detector detects the input image as a PAL film image, the motion compensating brightness calculator calculates the brightness of the subfield comprised in the first frame on the basis of the brightness of the first frame and a first vector different in direction from and comprising half the magnitude of the motion vector, and calculates the brightness of the subfield comprised in a third frame continuous to and repeated from the first frame on the basis of the brightness of the second frame and a second vector comprising a direction corresponding to a direction of the motion vector and comprising half the magnitude of the motion vector.

4. The display apparatus according to claim 2, wherein the pattern determiner further comprises a film image detector to detect whether the input image comprises a film image on the basis of the pattern of the frame, and
when the film image detector detects the input image as a National Television System Committee (NTSC) film image and determines the number of repetitive frames is three, the motion compensating brightness calculator calculates at least one of the brightness of the subfield comprised in the first frame among the repetitive three frames based on the brightness of the first frame and a first vector different in direction from the motion vector and comprising ⅓ magnitude of the motion vector; the brightness of the subfield comprised in the third frame among the repetitive three frames on the brightness of the second frame and a second vector comprising a direction corresponding to the direction of the motion vector and comprising ⅓ magnitude of the motion vector; the brightness of at least one subfield comprised in the second frame among the repetitive three frames based on the brightness of the first frame and a third vector different in direction from the motion vector and comprising the half magnitude of the motion vector; and the brightness of the other subfields comprised in the second frame based on the brightness of the second frame and a fourth vector comprising a direction corresponding the direction of the motion vector and comprising half the magnitude of the motion vector.

5. The display apparatus according to claim 3, wherein the emission pattern selector selects the subfield as an emission state when difference between the motion compensating brightness and the integral brightness is larger than a linear brightness.

6. The display apparatus according to claim 4, wherein the emission pattern selector selects the subfield as an emission state when a difference between the motion compensating brightness and the integral brightness is larger than the linear brightness.

7. A method of controlling a display apparatus representing gradation of an input image by a timesharing method using a subfield, the method comprising:
determining a frame pattern of the input image;
calculating a motion vector on the basis of a first frame corresponding to a first presented frame among the frames of a repetitive pattern, and a second frame corresponding to an image that is different from the frames of the repetitive pattern after the repetitive pattern is generated, when the input image includes the repetitive pattern;
calculating motion compensating brightness at the beginning of each subfield according to the motion vector;
calculating integral brightness of the quantity of light emitted in the subfield for a reference period of time along the motion vector; and
selecting whether light is emitted in the subfield on the basis of the motion compensating brightness and the integral brightness.

8. The method according to claim 7, wherein the calculating of motion compensating brightness comprises
calculating the brightness of at least one subfield among a plurality of subfields, comprised in the frames from the first frame before the second frame is started, based on the brightness of the first frame and the motion vector; and
calculating the brightness of the other subfields among the plurality of subfields on the basis of the brightness of the second frame and the motion vector.

9. The method according to claim 8, wherein the determining of a frame pattern comprises detecting whether the input image is a film image on the basis of the pattern of the frame, and
when the input image is detected as a PAL film image, the calculating of motion compensating brightness comprises calculating the brightness of the subfield comprised in the first frame on the basis of the brightness of the first frame and a first vector different in direction from and comprising half the magnitude of the motion vector; and calculating the brightness of the subfield comprised in the third frame continuous to and repeated from the first frame on the basis of the brightness of the second frame and a second vector comprising a direction corresponding to a direction of the motion vector and comprising half the magnitude of the motion vector.

10. The method apparatus according to claim 8, wherein the determining of a frame pattern comprises detecting whether the input image is a film image on the basis of the pattern of the frame, and when the input image is detected as a National Television System Committee (NTSC) film image and the number of repetitive frames is determined as three, the calculating of motion compensating brightness comprises calculating at least one of the brightness of the subfield comprised in the first frame among the repetitive three frames on the basis of the brightness of the first frame and a first vector different in direction from the motion vector and comprising ⅓ magnitude of the motion vector; the brightness of the subfield included in the third frame among the repetitive three frames on the brightness of the second frame and a second vector comprising a direction corresponding to the direction of the motion vector and comprising ⅓ magnitude of the motion vector; the brightness of at least one subfield comprised in the second frame among the repetitive three frames on the basis of the brightness of the first frame and a third vector different in direction from the motion vector and comprising the half magnitude of the motion vector; and the brightness of the other subfields included in the second frame on the basis of the brightness of the second frame and a fourth vector comprising a direction corresponding to the direction of the motion vector and comprising the half magnitude of the motion vector.
